(19) United States
(12) Patent Application Publication
(10) Pub. No.: US 2021/0256549 A1
(43) Pub. Date: Aug. 19, 2021

(54) Optimization of Delivery Associate Incentives

(71) Applicant: DoorDash, Inc., San Francisco, CA (US)

(72) Inventors: Jiarui Ren, San Francisco, CA (US); Raghav Ramesh, South San Francisco, CA (US); Sifeng Lin, Millbrae, CA (US)

(73) Assignee: DoorDash, Inc., San Francisco, CA (US)

(21) Appl. No.: 16/790,426

(22) Filed: Feb. 13, 2020

(51) Int. Cl. G06Q 30/02; G06Q 10/08; G06N 20/00; G06Q 10/06

(52) U.S. Cl. CPC G06Q 30/0208; G06Q 30/0205; G06Q 10/06398; G06N 20/00; G06Q 10/083

(57) ABSTRACT

Provided are various mechanisms and processes for generating delivery associate incentive values. In some implementations, predicted demand can be generated based on a first set of historical data and predicted supply can be generated based on a second set of historical data. Delivery quality values can be generated based on the predicted demand and the predicted supply. The delivery quality values can be used to determine incentive values that are provided to delivery associates of an on-demand delivery platform.

### TECHNICAL FIELD

The present disclosure relates to delivery associate incentives of on-demand deliveries. In one example, the present disclosure relates to mechanisms and processes for determining incentives for delivery associates.

### BACKGROUND

For delivery platforms, particularly for real-time on-demand deliveries of perishable goods, the cost per delivery can include bonus incentives of significant cost to delivery associates. Bonus incentives can be used when the delivery platform may need additional supply of delivery associates. The incentives can help ensure that a proper supply and demand balance is met, particularly during demand peaks which can be the majority of total demand on a given day. Bonus incentives can be created ahead of time so that delivery associates are able to plan ahead and schedule the times that they will make deliveries. Balancing the need to stay within budget while ensuring adequate delivery quality can be challenging.

Current systems and techniques to set incentive amounts are limited. For example, previous approaches include human administrators manually examining historical data and examples of incentive values for delivery associates that had been selected. From there, educated guesses using this historical data by the administrators was the manner in which future incentive values were selected—inefficiency and human error was often the result.

Consequently, it is desirable to provide improved mechanisms for determining the incentive values selected for delivery associates while balancing the delivery quality of the on-demand delivery platform while remaining within a budget.

### BRIEF DESCRIPTION OF THE DRAWINGS

The disclosure may best be understood by reference to the following description taken in conjunction with the accompanying drawings, which illustrate particular embodiments of the present disclosure.

FIG. 1 illustrates one example of a delivery logistics system having multiple merchants, couriers, and customers, in accordance with one or more embodiments.

FIG. 2 illustrates a diagram of an example network architecture for implementing various systems and methods of the present disclosure, in accordance with one or more embodiments.

FIG. 3 illustrates an example method for optimizing delivery associate incentives, in accordance with one or more embodiments.

FIG. 4 illustrates an example of a system 400 for optimizing delivery associate incentives, in accordance with one or more embodiments.

FIGS. 5A and 5B illustrate examples of incentive values for delivery associates according to different budgets, in accordance with one or more embodiments.

FIGS. 6A and 6B illustrate examples of a delivery logistics system having different representations of the number of delivery associates available using different incentive values, in accordance with one or more embodiments.

FIG. 7 illustrates a particular example of a computer system that can be used with various embodiments of the present disclosure

### DETAILED DESCRIPTION OF PARTICULAR EMBODIMENTS

Reference will now be made in detail to some specific examples of the disclosure including the best modes contemplated by the inventors for carrying out the disclosure. Examples of these specific embodiments are illustrated in the accompanying drawings. While the present disclosure is described in conjunction with these specific embodiments, it will be understood that it is not intended to limit the disclosure to the described embodiments. On the contrary, it is intended to cover alternatives, modifications, and equivalents as may be included within the spirit and scope of the disclosure as defined by the appended claims.

In the following description, numerous specific details are set forth in order to provide a thorough understanding of the present disclosure. Particular embodiments of the present disclosure may be implemented without some or all of these specific details. In other instances, well-known process operations have not been described in detail in order not to unnecessarily obscure the present disclosure.

For example, the techniques of the present disclosure will be described in the context of particular protocols, such as Wi-Fi or Bluetooth. However, it should be noted that the techniques of the present disclosure may also be applied to variations of protocols. In the following description, numerous specific details are set forth in order to provide a thorough understanding of the present disclosure. Particular example embodiments of the present disclosure may be implemented without some or all of these specific details. In other instances, well-known process operations have not been described in detail in order not to unnecessarily obscure the present disclosure.

Various techniques and mechanisms of the present disclosure will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present disclosure unless otherwise noted. Furthermore, the techniques and mechanisms of the present disclosure will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

With regard to the present disclosure, real-time on-demand deliveries of perishable goods may be requested by various users in a delivery platform system. Such users may include customers that are browsing merchants, such as restaurants. As used herein, the term “provider” may be used to describe various types of merchants that provide goods, including perishable goods, and the terms “provider” and “merchant” may be used interchangeably. As used herein, the term “delivery associate” may be used to describe a driver or courier that delivers the goods provided by the merchant to a customer, and the terms “delivery associate” and “courier” may be used interchangeably.

### Example Embodiments

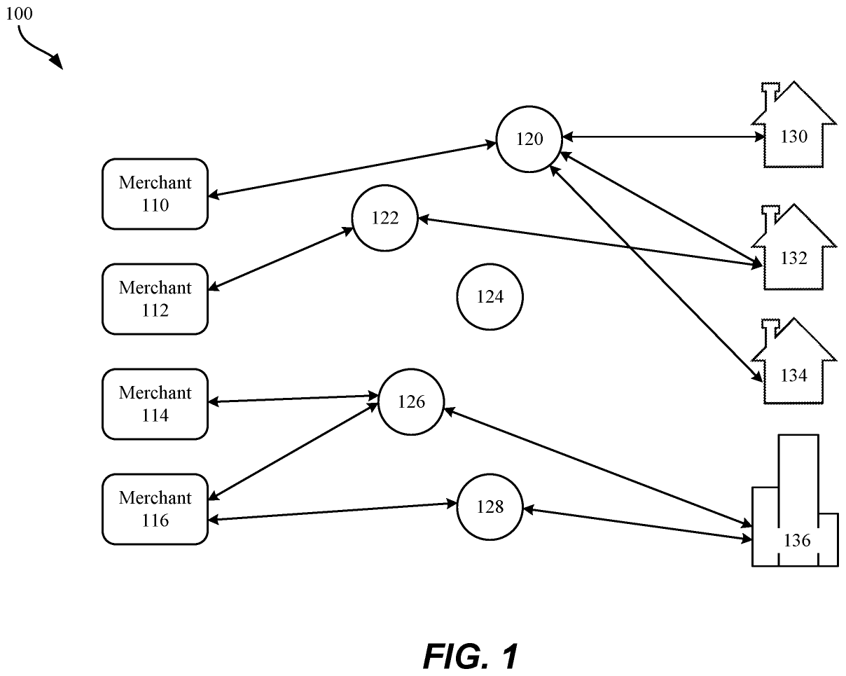

With reference to FIG. 1, shown is an example of a delivery platform system 100 implemented for multiple merchants, couriers, and customers, in accordance with one or more embodiments. As used herein, the term “delivery logistics system” may be used interchangeably with the terms “on-demand delivery platform,” “logistics platform,” or “delivery platform.” In the present example, the delivery platform system 100 provides real-time, on-demand, delivery of perishable goods. For instance, a customer may order food from a restaurant by using a mobile device application that places the order through the delivery platform. In some instances, the user may also access the delivery platform through the internet via a computer, laptop, tablet, etc. When the customer orders the food through the delivery platform, the order is prepared at a provider site, where a delivery associate will then pick up the order and deliver the order from the provider site to the customer.

As shown in FIG. 1, system 100 includes providers 100, 112, 114, and 116. According to various examples, a provider may be a merchant that prepares perishable goods such as food at a restaurant. Other such merchants may be any combination of one or more of the following: restaurants, bars, cafes, or other vendor of food or beverages, such as a hotel. Such venues may also be referred to herein as HORECA (Hotel/Restaurant/Café), which is a term or abbreviation used to describe entities in the food service industry.

However, in some examples, provider sites may also provide other perishable goods such as floral arrangements, medications, refrigerated or frozen items, live animals, etc. that may need real-time, on-demand delivery to a customer. Accordingly, although various examples in the present disclosure may describe the provider sites and delivery platform in the context of restaurants and food delivery, the mechanisms and processes described herein may also be applied to the delivery of various other perishable and non-perishable items. As used herein, the terms “provider” and “merchant” may be used interchangeably.

System 100 also includes one or more couriers 120, 122, 124, 126, and 128. Such couriers may be on foot or traveling by vehicle, such as a car, scooter, bicycle, etc. In various embodiments of system 100, one or more couriers may be directed to one or more merchants to receive an order placed by customers and deliver the orders to the customers located at corresponding destinations 130, 132, 134, or 136, which may be residential or commercial addresses. In some embodiments, the destinations may correspond to a particular geo-location determined by GPS or other coordinate system.

In various embodiments, the delivery platform may determine the estimated time arrival (ETA) of delivery of the order to the customer once the order has been placed. This ETA may be provided to the customer. The ETA of delivery of an order may be estimated based on tracked events or milestones corresponding to the order. As used herein, the terms “events” may be used interchangeably with “milestones.” The customer may also be provided with information regarding the status of the order, events, or milestones. The customer may also be provided with other information, such as information corresponding to the courier, etc. Information regarding the status of the order, events, or milestones may also be provided to the merchants and the couriers.

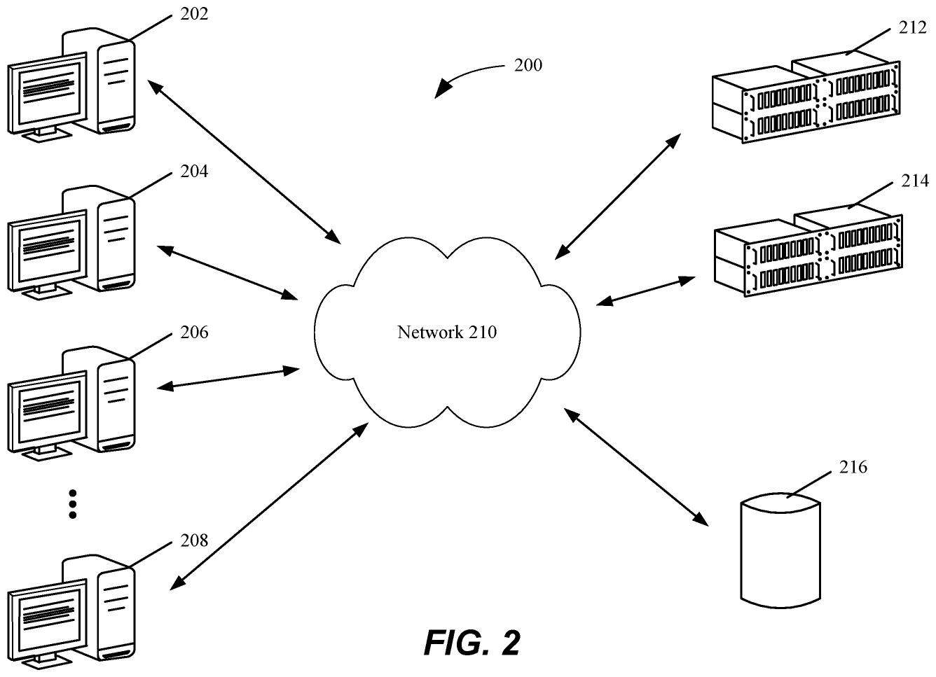

In various embodiments, one or more of the events described herein may be transmitted to client devices corresponding to customers, merchants, or couriers. FIG. 2 illustrates a diagram of an example network architecture 200 for implementing various systems and methods of the present disclosure, in accordance with one or more embodiments. The network architecture 200 includes a number of client devices 202-208 communicably connected to one or more server systems 212 and 214 by a network 210. In some embodiments, server systems 212 and 214 include one or more processors and memory. The processors of server systems 212 and 214 execute computer instructions (e.g., network computer program code) stored in the memory to perform functions of a network data exchange server. In various embodiments, the functions of the network data exchange server may include routing real-time, on-demand, delivery of perishable goods, and/or predicting and dynamically updating estimated time of arrivals (ETAs) for such deliveries.

In some embodiments, server system 212 is a content server configured to receive and store network profile information. In some embodiments, server system 214 is a dispatch server configured to transmit and/or route network data packets including network messages. In some embodiments, content server 210 and dispatch server 212 are configured as a single server system that is configured to perform the operations of both servers.

In some embodiments, the network architecture 200 may further include a database 216 communicably connected to client devices 202-208 and server systems 212 and 214 via network 210. In some embodiments, network data, or other information such as user information, courier information, and merchant information, may be stored in and/or retrieved from database 216.

Users of the client devices 202-208 access the server system 212 to participate in a network data exchange service. For example, the client devices 202-208 can execute web browser applications that can be used to access the network data exchange service. In another example, the client devices 202-208 can execute software applications that are specific to the network (e.g., networking data exchange “apps” running on smartphones).

Users interacting with the client devices 202-208 can participate in the network data exchange service provided by the server system 212 by distributing digital content, such as text comments (e.g., updates, announcements, replies), digital photos, videos, online orders, payment information, activity updates, location information, or other appropriate electronic information. In some implementations, information can be posted on a user's behalf by systems and/or services external to the network or the server system 212. For example, the user may post a review of a restaurant to a restaurant review website, and with proper permissions, that website may cross-post the review to the network on the user's behalf. In another example, a software application executed on a mobile device, with proper permissions, may use global positioning system (GPS) capabilities to determine the user's location and automatically update the network with his location (e.g., “At Home”, “At Work”, “In San Francisco, Calif.”).

In some implementations, the client devices 202-208 can be computing devices such as laptop or desktop computers, smartphones, personal digital assistants, portable media players, tablet computers, or other appropriate computing devices that can be used to communicate with an electronic social network. In some implementations, the server system 212 can include one or more computing devices such as a computer server. In various embodiments, each of client devices 202-208 may be any one of merchant devices corresponding to merchants 110-116, courier devices corresponding to couriers 120-128, or customer devices corresponding to customers 130-136.

In some implementations, the server system 212 can represent more than one computing device working together to perform the actions of a server computer (e.g., cloud computing). In some implementations, the network 210 can be a public communication network (e.g., the Internet, cellular data network, dial-up modems over a telephone network) or a private communications network (e.g., private LAN, leased lines).

Various customers, merchants, and couriers may transmit and receive information related to one or more orders to the servers 212 or 214 via corresponding client devices. The system may then utilize information received from various devices to calculate the ETA of the delivery of the order, as well as dynamically updating the ETA when updated timestamps are received. The predicted ETAs may further be used by a delivery routing system for pairing orders to couriers and merchants for delivery. Such information may include order information, payment information, activity updates, timestamps, location information, or other appropriate electronic information. For example, a selection of one or more merchants may be received from a customer device with a request to view available items for order. Information corresponding to the selected merchants may be retrieved from database 216 and transmitted to the customer device.

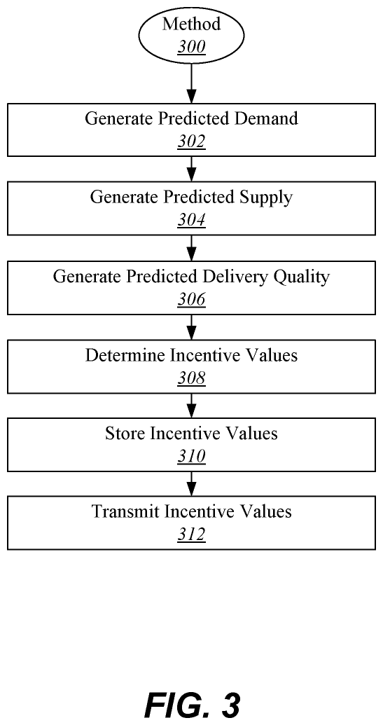

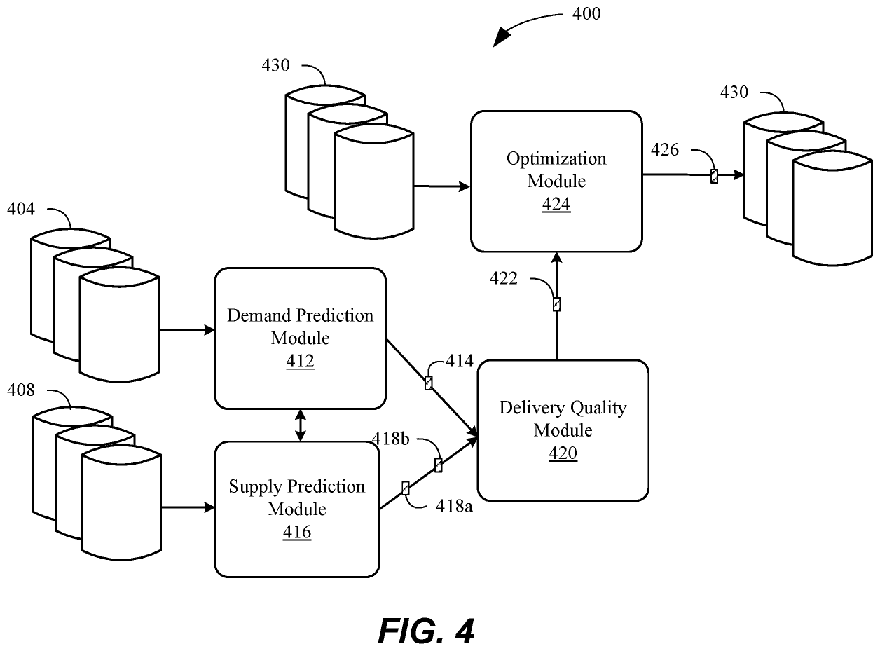

FIG. 3 is an example method for determining incentive values for delivery associates in an on-demand delivery platform, in accordance with one or more embodiments. A specific implementation method 300 will now be described with reference to the computing environment of FIG. 4.

At block 302, predicted customer demand values are generated. In some implementations, demand prediction module 412 of FIG. 4 generates the predicted demand using data from database 404. In other implementations, system 400 alone or in combination with demand prediction module 412 generates the predicted demand.

In some implementations, predicted customer demand is generated based in part on historical demand data. An on-demand delivery platform may capture past customer activity and store it in one or more databases, e.g., database 404. The historical customer demand data can be aggregated such that a total number of deliveries for a particular time frame in a particular region.

In some implementations, a machine learning algorithm is used to generate the predicted demand values of block 302 of FIG. 3. The machine learning algorithm can be a decision tree-based algorithm trained using historical demand data from database 404. In some implementations, the machine learning algorithm is incorporated as part of logic included in demand prediction module 412. Alternatively, the machine learning algorithm can be implemented as an independent component of system 400.

The machine learning algorithm for predicting demand can adjust and/or refine predicted demand based on factors that may have had an effect upon the historic demand unrelated to the incentive provided prior to the day of delivering customer orders. For example, predicted supply can be influenced by other types of incentives, e.g., reactive incentives provided to delivery associates in real-time to increase delivery associates for a particular period of time in a region. Thus, the predicted demand 414 provided to delivery quality module 420 can be offset by the number of delivery associates that started delivering orders to customers in response to the reactive orders.

Prediction demand module 412 can include the actual deliveries that delivery associates completed and deliveries that might have been lost due to an inadequate number of delivery associates. For example, a customer might not complete an order transaction from a restaurant because the estimated delivery time is longer than the customer is willing to wait before eating. As such, a customer may choose to use a competitor's on-demand delivery platform to receive the same meal from the same restaurant that has a lower estimated delivery time because the competitor's on-demand delivery platform has more available delivery associates. In this case, demand prediction module 412 identifies the missed opportunity and includes this type of situation in the process of generating the predicted demand value.

Predicted demand values can be generated according to different categories of historical data from database 404. In some implementations, the historical demand data is categorized according to the historical customer order data for a particular region. For example, predicted demand is generated for customers located in the North Beach neighborhood of San Francisco. Demand prediction module 412 can identify numerous geographic regions and provide a predicted demand value for each of those regions. In some cases, the predicted demand values might be the same across multiple regions (e.g., 1,000 deliveries to customers for West Berkeley and 1,000 deliveries to customers for the Elmwood neighborhood of Berkeley) but it could also be different (e.g., 1,000 deliveries to customers for West Berkeley and 1,200 deliveries customers for the Elmwood neighborhood of Berkeley). Demand prediction module 412 can identify regions according to different levels of granularity, e.g., subsections of a neighborhood, separate neighborhoods, cities, a combination of cities, counties, states, etc.

The geographic areas described above can be changed and updated over time as populations change, neighborhoods change, etc. As mentioned above, the level of granularity at which a particular region has a predicted demand value generated will depend on the density of the population along with the delivery capacity of the on-demand delivery platform. For example, in a city such as Berkeley, Calif. that has a relatively dense population in certain areas, demand prediction module 412 might generate a predicted demand for the West Berkeley Neighborhood, the Elmwood neighborhood, Downtown Berkeley, etc. In contrast to the city of Berkeley, a state with a smaller population like Wyoming might only have a few regions for the entire state. However, if Wyoming has a large increase in population, more regions can be created, and predicted demand values for those regions can be generated accordingly.

Alternatively, historical data of database 404 is categorized according to geographic areas that share similar features. In some implementations, features for geographic regions are determined by the machine learning algorithm described above or implemented as separate logic included as part of demand prediction module 412. The features identified by demand prediction module 412 can include customer demographics (age, gender, socioeconomic background, etc.). Also or alternatively, additional customer features might include a similar customer order history that occurs in a particular geographic region, e.g., a group of customers that really enjoy a particular kind of spicy chicken and rice meal. Also or alternatively, merchant features may be identified and used to group similar customers together such as the number of restaurants, the popularity of the restaurant (e.g., the frequency with which customers order), ratings of the restaurants, the number of a particular type of restaurant (e.g., five Mexican food restaurants and three Italian food restaurants). Also or alternatively, the density of a customer population in relation to the number of restaurants available on the delivery might also be factor.

The data used for generating predicted demand may also be categorized according to other categories besides geographic region. In some implementations, predicted demand might be categorized according to periods of time (e.g., lunch time or dinner time). For example, predicted demand values might be generated for customers orders between 11:00 AM and 1:00 PM, and a separate predicted demand might be generated for customer orders between 6:00 PM and 9:00 PM.

In some implementations, predicted customer demand is generated for a combination of categories, e.g., region and periods of time. For example, predicted customer demand can be generated for customers in the Elmwood neighborhood ordering between 6:00 PM and 9:00 PM and customers in the West Berkeley neighborhood ordering deliveries between 6:00 PM and 9:00 PM. Additionally, customer demand for one region might have one predicted demand value for customers at one period of time and have a different value for another period of time, for instance, predicted demand in the Elmwood neighborhood might be 500 deliveries to customers between 11:00 AM and 1:00 PM, while the predicted demand might be 2000 deliveries to customers between 6:00 PM and 9:00 PM.

In some implementations, the categories used by demand prediction module 412 are selected manually by an administrator. For example, the regions are identified and selected manually by an administrator that groups certain addresses, neighborhoods, cities, etc. together. Similarly, the regions of time can be selected by an administrator, e.g., the administrator demand for all orders between 10:00 AM and 12:00 PM. In other implementations, the categories are generated automatically by the demand prediction module 412. Instead of preselecting regions by an administrator, regions that have similar characteristics (as described above) have predicted demand values generated accordingly.

The manner and frequency in which predicted demand is generated or updated may vary. Demand prediction module 412 might generate predicted demand values for all regions of the on-demand delivery platform at the same time. Also or alternatively, demand prediction module 412 might generate predicted demand values for some of the regions at different times. For example, predicted demand values might need to be updated for each region in San Francisco. As such, demand prediction values would only be generated for that subsection of regions.

In some implementations, predicted demand values are generated periodically. In one example, predicted demand values are generated monthly. In this case, predicted demand values for the month of April might be generated in March. In one example, predicted customer demand is generated on a weekly basis. In this case, the predicted customer demand might be generated for the subsequent week. In another example, predicted customer demand is generated on a daily basis. In this case, predicted customer demand is generated for the next day, e.g., on Monday, predicted demand values are generated for Tuesday. In some implementations, each type of period is used in combination. For example, a monthly forecast of predicted demand can be generated with each week's demand being updated the week prior, and if necessary, updated again the day before.

In some implementations, the predicted customer demand described above is generated manually by an administrator according to the period of time, but in other implementations, the predicted customer demand is automatically generated according to the period of time. In addition to the different techniques for generating predicted demand values described above, in some implementations, the predicted demand values that are generated might be the actual demand from that day of the previous week. For example, predicted customer demand for an upcoming Monday would be the previous Monday that occurred seven days prior. Alternatively, the predicted customer demand values that are used might be the actual demand from that day or closest equivalent day (e.g., the second Monday of March.) of the previous year. In other implementations, predicted customer demand is generated in response to a request for user input, e.g., an administrator may manually select the historical data to use for generating predicted demand.

At block 304 of FIG. 3, predicted supply values are generated. In some implementations, supply prediction module 416 of FIG. 4 generates predicted supply values 418a and 418b using data from database 408. In other implementations, system 400 alone or in combination with supply prediction module 416 generates the predicted demand. In some implementations, customer demand is influenced by the number of delivery associates available, and as such, customer demand may increase with an increase in the availability of delivery associates. Because of this, supply prediction module 416 and demand prediction module 412 might be used in combination in order to find a subsequent predicted supply or predicted demand value.

In some implementations, predicted supply is generated based in part on historical supply data. An on-demand delivery platform may capture historic delivery associate numbers at different times and store it in one or more databases, e.g., database 408. The historical supply data can be aggregated such that a total number of delivery associates for a particular time frame in a particular region at different incentive values. Historical supply data of database 408 can include the actual number of delivery associates that were delivering customer orders with a corresponding incentive value that had been selected. In addition, the number of delivery associates may be categorized according to region and period of time (e.g. lunchtime, dinner time, neighborhoods, etc.).

In some implementations, a machine learning algorithm is used to generate the predicted supply values of block 304 of FIG. 3. In some implementations, the machine learning algorithm is incorporated as part of logic included in supply prediction module 412 of FIG. 4. Alternatively, the machine learning algorithm can be implemented as an independent component of system 400. In some implementations, the machine learning algorithm for generating predicted supply values can be a decision tree-based algorithm trained using historical demand data from database 408.

In some implementations, the initial historical supply data of database 408 that is provided to supply prediction module 416 is based on incentive values that had been selected by human administrators, i.e., using previous methods to address delivery associate incentive optimization discussed above. In other implementations, as the optimization techniques have been running for some time, predicted supply values can be refined such that the supply data identified by supply prediction module 416 is based on the incentives that have been chosen by the optimizer module. In some implementations, as the number of predicted supply iterations occur, the actual supply numbers that occur as a result of the incentive values chosen using optimization module 424 might be given additional weight by supply prediction module 416 when selecting the number of delivery associates for an incentive value.

In some implementations, predicted supply values are influenced by other types of incentives used to increase the actual number of delivery associates. For example, reactive incentives are additional incentives provided to delivery associates the day that the delivery associate would perform deliveries. In this case, the amount of predicted demand might be offset by the number of delivery associates added to the total delivery associate supply in response to the reactive incentive.

In some implementation, predicted supply values can be generated for regions, particular times, and historical incentive values. A particular time and region can have multiple values generated according to multiple incentive values. For example, in a region such as a North Beach in San Francisco, predicted supply values might include 50 delivery associates for an incentive value set at one dollar and 70 delivery associates or incentives set at two dollars.

In some implementations, historical supply data that is used by predicted supply module 416 can be aggregate supply data according to different measurements of time and characteristics. For example, predicted supply module 416 might aggregate the past year's deliveries, the last six months, the last three months, etc. In other examples, predicted supply module 416 aggregates data according to all Mondays within the past year. In some other examples, predicted supply module 416 aggregates historical data regarding just lunchtime deliveries or just dinner time deliveries.

In other implementations, predicted supply module 416 can predict how many new delivery associates should be hired to meet a certain demand number. In some implementations, prior to predicting the number of new delivery associates that should be hired. Predicted supply module 416 can predict how many delivery hours the on-demand delivery platform receives from the existing pool of delivery associates. The predicted productivity out of the existing delivery associate can be used as a basis for the number of new delivery associates to be hired. Delivery associate characteristics can be identified such as historical demand and the proportion of new delivery associates and more veteran delivery associates that provided adequate delivery quality to that customer demand. The proportion of delivery associates can be also be categorized according to the number of delivery associates that have been driving for one month, the number of delivery associates that have been driving for two months, the number of delivery associates that have been driving for three months, and the average number of hours that those delivery associates typically.

At block 306 of FIG. 3, delivery quality values are generated. Delivery quality values can represent a proxy for delivery quality, discussed further below. In some implementations, predicted demand values 414 of FIG. 4 and predicted supply values 418a and 418b are used as inputs by delivery quality module 420. In some implementations, delivery quality module 420 generates delivery quality values 422 for each region, period of time, and incentive value. In other implementations, system 400 alone or in combination with delivery quality module 416 generates the quality values based on demand values 414 and predicted supply values 418a and 418b.

In some implementations, delivery quality module 420 simulates delivery quality by estimating delivery duration, demand distribution, supply distribution, and incentive values. In some implementations, delivery quality is a representation of the supplier state across the on-demand delivery platform. The supplier state can be the ratio of delivery associates to customers at a given moment.

In some implementations, delivery quality module 420 generates delivery quality values for each incentive value of a region and period of time (e.g., West Berkeley deliveries between 6:00 PM and 9:00 PM for $1, $2, and $3 incentive values). The delivery quality can change over time, including during a particular time period. For example, if there are steady customer orders during dinner time in West Berkeley and there is a sufficient number of delivery associates, e.g., ratio of delivery associates to customers is such that the number of outstanding deliveries is less than a threshold value representing the maximum allowable outstanding deliveries.

As mentioned above, predicted demand values can be categorized in a variety of ways. In some implementations, predicted demand might be generated according to 30-minute intervals. As such the predicted demand value for a 30-minute interval can be distributed smoothly by the minute across the 30-minute interval. Similarly, for that same 30-minute interval, the total predicted supply can be spread smoothly by the minute across a 30-minute interval in a similar manner. Delivery quality module 420 can use the minute-by-minute distribution in order to come up with an accurate quality value for all times of the day. Besides a minute-by-minute basis, different periods of time may be used for a 30-minute interval. For example, a two-minute smoothing sample, five-minute smoothing sample, ten-minute smoothing sample, etc.

TABLE 1

| | Time Period | | |
|---|---|---|---|
| Incoming Deliveries | 10 | 10 | 10 |
| Outstanding Deliveries | 10 | 20 | 30 |
| Delivery Associates | 8 | 10 | 12 |
| Delivery Quality | 1.25 | 2 | 2.5 |

Table 1 shows a 30-minute window for a particular geographic region. For the first smoothing sample, there are 10 incoming deliveries, 10 outstanding deliveries, and 8 associates. As such, the delivery quality value for that sampling period is 1.25. For the second smoothing sample, there are 10 incoming deliveries, 20 outstanding deliveries, and 10 associates. As such, the delivery quality value for that sampling period is 2. For the third smoothing sample, there are 10 incoming deliveries, 30 outstanding deliveries, and 12 delivery associates. As such, the delivery quality value for that sampling period is 2.5.

In some implementations, delivery quality values for a geographic region must be below a threshold value representing the maximum allowable outstanding deliveries. In some implementations, threshold values are set automatically by delivery quality module 420. Also or alternatively, the threshold value can be set manually by an administrator. For example, a region may have a threshold value of 2. If an incentive value for a region resulted in a delivery quality value at 2.5, then that incentive value would not be provided to optimization module 424. In other implementations, the quality threshold value does not prohibit a predicted supply value from being sent to the optimizer module. This could be the case where a threshold value is set at a global level.

Also or alternatively, optimization module 424 can estimate supplier quality using predicted demand and predicted supply from historical data that is not influenced by the simulator or by the optimizer. This may be done initially while optimization module 424 is relying on delivery quality values that have been generated based on predicted demand values and predicted supply values not generated by demand prediction module 412 or supply prediction module 416. In particular, this could be the case for the machine learning algorithms that initially start the training process of generating predicted demand and predicted supply values. As time passes, estimated delivery quality can be compared to the actual supplier quality that occurs. This comparison can be used by delivery quality module 420 to further refine the supplier quality estimations.

At block 308 of FIG. 3 incentive values are determined. In some implementations, optimization module 424 of FIG. 4 determines incentive values 426 using data from database 430 and delivery quality values 422 from delivery quality module 420. In other implementations, system 400 alone or in combination with supply prediction module 416 generates the predicted demand.

In some implementations, optimization module 424 includes an integer programming model that is configured to choose incentive values from among the simulated delivery quality for each incentive value for each region. In some implementations, the objective function of the integer programming model is to maximize delivery quality, while the constraints are that the total cost of all the incentive values should be less than a budget value and that there is one incentive value selected for each region and time of day.

Constraints of the integer programming model can be modified as necessary. For example, an administrator may change the overall budget value from $1 million to $1.25 million. This might be done because delivery associate performance for the on-demand delivery platform might be a higher priority and as such supplier quality would increase at the expense of a higher budget. Likewise, the overall budget can be decreased if saving money becomes an increased priority.

In some implementations, optimization module 424 can determine incentive values using one budget, e.g., $100,000. In other implementations, optimization module 424 determines incentive values using more than one budget, e.g., $100,000 and $200,000. In still other implementations, optimization module 424 determines incentive values using a range of budgets, e.g., $100,000 through $200,000.

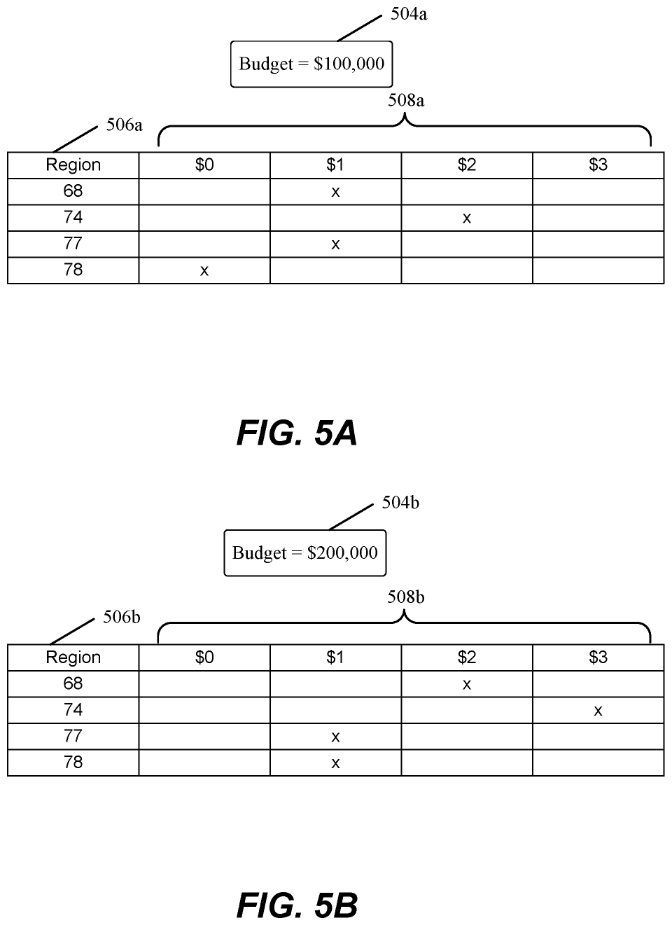

FIGS. 5A and 5B illustrate examples of incentive values for delivery associates according to different budgets, in accordance with one or more embodiments. In FIG. 5A, budget 504a is $100,000 for all regions serviced by an on-demand delivery platform. There are four regions 506a shown, region 68, region 74, region 77, and region 78. In addition, four incentive values 508a are shown, $0, $1, $2, and $3. In FIG. 5A, an incentive value of $1 has been selected for region 68, an incentive value of $2 has been selected for region 74, an incentive value of $1 has been selected for region 77, and an incentive value of $0 has been selected for region 78. In FIG. 5B, regions 506b and incentive values 508b are the same as in FIG. 5A. However, budget 504b is $200,000 for regions 506b. The selected incentive values of FIG. 5B show how with an increased budget greater incentive values may be selected. In FIG. 5B, an incentive value of $2 has been selected for region 68, an incentive value of $3 has been selected for region 74, an incentive value of $1 has been selected for region 77, and an incentive value of $1 has been selected for region 78. While the above example shows incentive values incremented according to dollar intervals, other scales of incrementation can be used, e.g., $0.01 increments, $0.05 increments, $0.10 increments, $0.25 increments, $0.50 increments, etc.

In some implementations, the constraints are adjusted manually by a system administrator. For example, an administrator manually adjusts the overall budget through a user interface that is configured for maintaining constraints of an optimization module 424. In other implementations, the constraints are adjusted automatically by optimization module 424. For example, after optimization module 424 has been setting incentive values for a period of time, the optimization module can leverage a data set of historical budgets and how they corresponded to selected delivery quality values. With that information, optimization module 424 can use refine the overall budget based on the more accurate information. For example, if the budget was set for $1 million, but optimization module 424 infers that a budget of $1,010,005 would lead to A much higher overall delivery quality, then the overall budget could be adjusted to that $1,010,005 value and optimized accordingly.

In some implementations, automatic adjustment using the suggested budget occurs without interaction from the system administrator. In other implementations, the suggested budget can be provided as a message to admin who then changes the budget manually.

In some implementations, multiple constraints might be used by the integer programming model to determine incentive values. For example, there may be a constraint for an overall budget and a constraint that there be one incentive per region. In another example, there might be constraints set on a per-region level, e.g., the West Berkeley neighborhood has a local budget of $1,000, and the Elmwood neighborhood has a local budget of $2,000.

It should be noted that the word “optimize” or any derivation thereof should not be construed as to indicate that the values that are derived are the optimal or ideal values. Optimize as used in this patent application shall refer to values that satisfy the objective function of the integer programming model while meeting the constraints of the integer programming model. And optimal value shall not refer to the best or only value that the incentive could be.

At block 310 of FIG. 3 incentive values are stored. In some implementations, incentive values 426 of FIG. 4 are stored in database 430. Incentive values 426 can be provided to an administrator for review and can also be provided as part of block 312 discussed further below.

At block 312 of FIG. 3 incentive values are transmitted. In some implementations, the incentive values are transmitted to user devices of delivery associates, e.g., a delivery associate's smartphone. In some implementations, the incentive values for a particular region are sent to delivery associates that have a driving history of making deliveries in that region. For example, a delivery associate might receive a notification on their smartphone that next Monday there is a $1 incentive for making deliveries in the Elmwood neighborhood. In this example, the delivery associate has a driving history of making deliveries in the Elmwood neighborhood. In other implementations, delivery associates receive incentive values for multiple regions. For example, a delivery associate might receive a notification for a $1 incentive for making deliveries in the Elmwood neighborhood and a $2 incentive for making deliveries in the West Berkeley neighborhood.

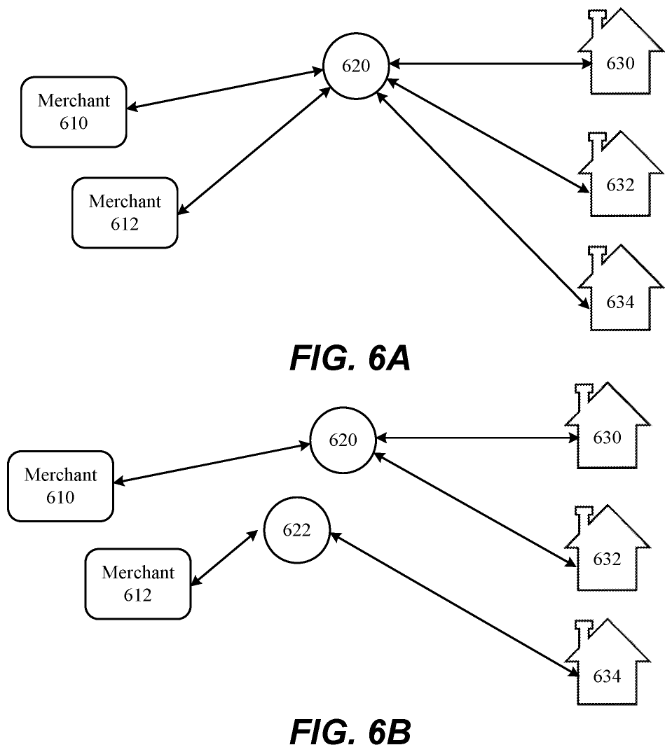

FIGS. 6A and 6B illustrate examples of a delivery logistics system having different representations of the number delivery associates available using different incentive values, in accordance with one or more embodiments. FIG. 6A and 6B show merchants 610 and 620, delivery associate 620, and customers 630,632, and 634. In FIG. 6B, there is an additional delivery associate 622. FIG. 6B shows an additional delivery associate 622 in response to having been provided an incentive value that encouraged delivery associate 622 to deliver in the region that merchant 612 and customer 634 are located.

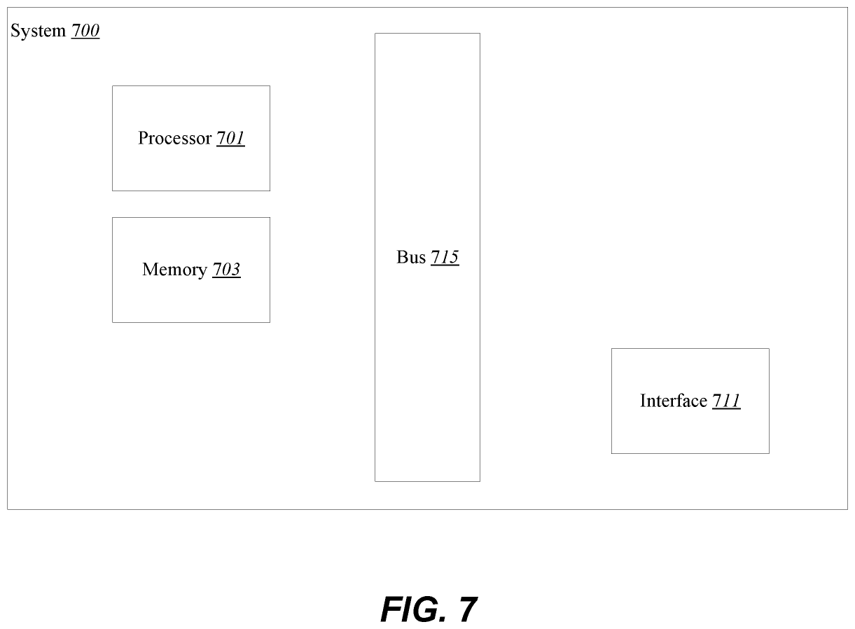

Various computing devices can implement the methods described herein. For instance, a mobile device, computer system, etc. can be used to generate incentive values, demand values, or supply values. With reference to FIG. 7, shown is a particular example of a computer system 700 that can be used to implement particular examples of the present disclosure. According to particular example embodiments, a system 700 suitable for implementing particular embodiments of the present disclosure includes a processor 701, a memory 703, an interface 711, and a bus 715 (e.g., a PCI bus). When acting under the control of appropriate software or firmware, the processor 701 is responsible for processing incentive values. In some embodiments, the processor is responsible for updating the parameters of the integer programming model and machine learning algorithms. Various specially configured devices can also be used in place of a processor 701 or in addition to processor 701. The complete implementation can also be done in custom hardware.

The interface 711 is typically configured to send and receive data packets or data segments over a network. Particular examples of interfaces the device supports include Ethernet interfaces, frame relay interfaces, cable interfaces, DSL interfaces, token ring interfaces, and the like. The interface 711 may include separate input and output interfaces, or may be a unified interface supporting both operations. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 700 uses memory 703 to store data and program instructions for operations including optimizing incentive values for delivery associates of an on-demand delivery platform, such as in methods 300. The program instructions may control the operation of an operating system and/or one or more applications, for example. The memory or memories may also be configured to store received metadata and batch requested metadata. The memory or memories may also be configured to store data corresponding to parameters and weighted factors.

Because such information and program instructions may be employed to implement the systems/methods described herein, the present disclosure relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present disclosure.

While the present disclosure has been particularly shown and described with reference to specific embodiments thereof, it will be understood by those skilled in the art that changes in the form and details of the disclosed embodiments may be made without departing from the spirit or scope of the disclosure. It is therefore intended that the disclosure be interpreted to include all variations and equivalents that fall within the true spirit and scope of the present disclosure.

What is claimed is:

1. A method comprising:
generating predicted demand based on a first set of historical data, the predicted demand representing customer demand of an on-demand delivery platform;
generating predicted supply based on a second set of historical data, the predicted supply representing available delivery associates of the on-demand delivery platform;
generating delivery quality values based on the predicted demand and the predicted supply;
determining incentive values using the delivery quality values; and
providing a first one of the determined incentive values to a delivery associate of the on-demand delivery platform.

2. The method of claim 1, wherein determining the incentive values using the delivery quality values includes:
identifying a first constraint and identifying a second constraint different from the first constraint;
identifying an objective function; and
selecting incentive values associated with delivery quality values according to the first constraint, the second constraint, and the objective function.

3. The method of claim 1, wherein generating the predicted supply includes using a machine learning algorithm configured to determine a first amount of delivery associates in relation to a first incentive value and determine a second amount of delivery associates in relation to a second incentive value.

4. The method of claim 1, wherein the predicted demand is categorized according to a geographical region and a period of time.

5. The method of claim 1, wherein the predicted supply includes a first incentive value for a geographical region and a second incentive value for the geographical region.

6. The method of claim 5, wherein generating delivery quality values includes generating a first delivery quality value based on the first incentive value for the geographical region and generating a second delivery quality value based on the second incentive value for the geographical region.

7. The method of claim 6, wherein determining the incentive values using the delivery quality values includes selecting the second incentive value as the first determined incentive value provided to the delivery associate.

8. An on-demand delivery platform including memory and a processor configured to cause:
generating predicted demand based on the first set of historical data, the predicted demand representing customer demand of the on-demand delivery platform;
generating predicted supply based on the second set of historical data, the predicted supply representing available delivery associates of the on-demand delivery platform;
generating delivery quality values based on the predicted demand and the predicted supply;
determining incentive values using the delivery quality values; and
providing a first one of the incentive values to a delivery associate of the on-demand delivery platform.

9. The on-demand delivery platform of claim 8, wherein determining the incentive values using the delivery quality values includes:
identifying a first constraint and identifying a second constraint different from the first constraint;
identifying an objective function; and
selecting incentive values associated with delivery quality values according to the first constraint, the second constraint, and the objective function.

10. The on-demand delivery platform of claim 8, wherein generating the predicted supply includes using a machine learning algorithm configured to determine a first number of delivery associates in relation to a first incentive value and determine a second number of delivery associates in relation to a second incentive value.

11. The on-demand delivery platform of claim 8, wherein the predicted demand is categorized according to a geographical region and a period of time.

12. The on-demand delivery platform of claim 8, wherein the predicted supply includes a first incentive value for a geographical region and a second incentive value for the geographical region.

13. The on-demand delivery platform of claim 12, wherein generating delivery quality values includes generating a first delivery quality value based on the first incentive value for the geographical region and generating a second delivery quality value based on the second incentive value for the geographical region.

14. The on-demand delivery platform of claim 13, wherein determining the incentive values using the delivery quality values includes selecting the second incentive value as the first determined incentive value provided to the delivery associate.

15. A computer program product comprising one or more non-transitory computer readable media having instructions stored thereon for performing a method, the method comprising:
generating predicted demand based on the first set of historical data, the predicted demand representing customer demand of an on-demand delivery platform;
generating predicted supply based on the second set of historical data, the predicted supply representing available delivery associates of the on-demand delivery platform;
generating delivery quality values based on the predicted demand and the predicted supply;
determining incentive values using the delivery quality values; and
providing a first one of the incentive values to a delivery associate of the on-demand delivery platform.

16. The computer program product of claim 15, wherein determining the incentive values using the delivery quality values includes:
identifying a first constraint and identifying a second constraint different from the first constraint;
identifying an objective function; and
selecting incentive values associated with delivery quality values according to the first constraint, the second constraint, and the objective function.

17. The computer program product of claim 15, wherein generating the predicted supply includes using a machine learning algorithm configured to determine a first amount of delivery associates in relation to a first incentive value and determine a second amount of delivery associates in relation to a second incentive value.

18. The computer program product of claim 15, wherein the predicted demand is categorized according to a geographical region and a period of time.

19. The computer program product of claim 15, wherein the predicted supply includes a first incentive value for a geographical region and a second incentive value for the geographical region.

20. The computer program product of claim 19, wherein generating delivery quality values includes generating a first delivery quality value based on the first incentive value for the geographical region and generating a second delivery quality value based on the second incentive value for the geographical region.
